(19) United States
(12) Patent Application Publication
(10) Pub. No.: US 2010/0123040 A1
(43) Pub. Date: May 20, 2010

(54) HELIUM-COOLED LEDS IN A FLOATING ILLUMINATION SYSTEM

(76) Inventors: Kevin C. Baxter, Van Nuys, CA (US); Ken S. Fisher, North Hollywoods, CA (US); Fred Holmes, Van Nuys, CA (US)

Correspondence Address: IRELL & MANELLA LLP, 1800 AVENUE OF THE STARS, SUITE 900, LOS ANGELES, CA, 90067, US

(21) Appl. No.: 12/487,255

(22) Filed: Jun. 18, 2009

Related U.S. Application Data
(60) Provisional application No. 61/074,140, filed on Jun. 19, 2008.

(51) Int. Cl. B64B 1/40; B64B 1/44; B64D 47/02; B60Q 1/14

(52) U.S. Cl. 244/31; 362/470; 315/77

(57) ABSTRACT

A balloon-mounted light source includes an array of LEDs mounted on, and cooled by, a balloon structure filled with a lightweight gas such as helium. The LEDs are preferably mounted in long series arrangements with small gauge wire to minimize weight. They may be mounted on heatsinks that are dispersed in a mesh-like structure over the balloon. The LED circuitry may also be mounted on flexible circuit boards, which may be porous to reduce weight. The balloon may include an envelope compartment with a leak-resistant seal or zipper to allow the interior of the envelope to be accessed, and a pressure relief valve. The envelope of the balloon may be clear in the front in order to maximize the projection of light but reflective along the back and sides as to minimize spill. The balloon may take the form of a controllable dirigible.

### RELATED APPLICATION INFORMATION

This application claims the benefit of U.S. Provisional Application Ser. No. 61/074,140, filed on Jun. 19, 2008.

### BACKGROUND OF THE INVENTION

1. Field of the Invention

The field of the invention generally relates to illumination devices and, more particularly, a lighter-than-air craft for providing illumination.

2. Background of Related Art

The use of lighter-than-air craft for projected lighting purposes is well known. Typically such devices include a helium filled balloon, or envelope, and an interior light source. Such balloons have been used to illuminate subjects for film and video, construction sites, emergency scenes, and other temporary situations. These devices are not to be confused with the proliferation of advertising balloons which are translucent and illuminated from within to bring visual attention to themselves and their advertising message. Advertising balloons light themselves rather than other subjects. Balloons used for projected lighting have light sources inside the balloons that shine out to illuminate ground based subjects and use light sources which are either powerful incandescent or high intensity arc discharge type lamps such as HMI, which has a color much like daylight. The advantage of these lights has been recognized by the motion picture industry in that they do not need support mechanisms such as light stands or cranes. One simply fills the envelope with helium and it floats up, taking the power supply cord with it. Consequently these balloons are commonly used to illuminate locations where the use of heavy cranes is impractical or impossible, e.g. where a floor would be damaged by driving across it, or where it is impractical or impossible to drill holes in ceilings or roof support structures, such as in buildings with historical value. Further, these balloons are often used for outdoor locations simply because they can rise to heights that are higher than support structures could otherwise allow.

Lighting balloons come in a variety of configurations, varying in size and shape, with or without internal reflectors, and systems for tethering. In a typical installation, the angle or attitude of a lighting balloon is controlled by small down lines, or tethers, that resemble fishing line and are nearly invisible from a distance. The operator adjusts the tension on various lines to control the orientation of the balloon. Internal reflectors are used to direct the light in a general direction rather than letting it spill evenly in every direction. Such reflectors are either positioned near the bulb or are integrated with the inside face of the envelope itself. By manipulating the tethers, the orientation of the balloon can be altered to change the direction that the light projects.

Lighting balloons generally have a translucent envelope that diffuses the light to some degree. This is required because there is usually more than one bulb inside a given envelope and they need to project onto the subjects as an integrated light source so as to not cause multiple shadows on the subject. Even envelopes with a single bulb generally need the diffusion because the lighting quality from a point-source such as a bare bulb is too harsh, with sharp edged shadows being projected, from an undiffused source. Beyond the advantage that the balloon does not need support structures, this ability to control the direction of the light has been the primary reason for the balloon's overwhelming success as a lighting tool for these industries which require temporary but controlled illumination.

One of the biggest drawbacks for illumination balloons is the amount of helium required to fill a balloon. Helium is very expensive making use of illumination balloons a relatively expensive proposition. In addition, the helium can only be used once and it slowly leaks out or passes directly through the envelope material, because it is one of the smallest of molecules and can pass through nearly all materials. Therefore the permeability of the envelope material has much to do with how long it will hold the buoyant gas. Also the overall weight of the envelope and bulbs affect the size of the envelopes. Larger bulbs and heavier envelopes require more helium and thus are more costly.

The weight of the envelopes used or illumination balloons depends on several factors including the type of material used. The envelope material is generally selected to be scuff and puncture resistance, impermeability, and ultraviolet (UV) filtering. The envelope typically needs a UV filter on the innermost surface to protect the rest of the envelope materials from being attacked by the UV rays from HMI bulbs as well as stopping the UV rays from going through the envelope and radiating subjects such as actors and film technicians with harmful light waves. Envelopes are commonly made from rip-stop nylon that provides strength and resistance to tearing. The nylon is then coated with an impermeable material such as silicone rubber, and a UV filter material that is usually adhered to the innermost side of the envelope in a multi-material sandwich or lamination of materials. This is a very expensive process that requires a high level of technical proficiency in order to build properly while keeping the weight to a minimum. The envelope material is made in flat sheets that are then cut into patterns and sewn together to make spherical or cylindrical shapes. Unfortunately, the sewing process makes thousands of small punctures in the material that helium can easily escape through so an additional process of adding an impermeable and UV resisting tape or sealant on the inside of the envelope over the sewn seams is required. This process leads to relatively heavy envelopes which cost several thousand dollars each.

Another problem is that the light diffusing materials used for illumination balloons, such as rip-stop nylon, are subtractive in nature and thus reduce the output intensity of the illumination. As the light passes through these materials, the light is scattered and spread as required, but a large percentage (e.g., nearly half) of the light is absorbed by the diffusing material itself and fails to reach the subject area. Also, as light bounces around inside the envelope, losses due to reflection occur. While more diffusion or less diffusion may be desired in some cases for a given lighting situation, the scatter or spread of the light as-is generally cannot be controlled except for adding more diffusion. To this end, some balloons are equipped with opaque skirts that are attached to the outside of the envelope with Velcro and can be adjusted to block the spread of the light—but these are again very subtractive in nature and tend to hang straight down with the pull of gravity. The amount of light lost to the envelope and the skirts can exceed 90% of the light generated by the bulbs depending on the amount of control required for a given situation.

Obtaining the proper color temperature when using an illumination balloon can also be challenging. Directors often ask for color temperatures that are different than the 3200 Kelvin light of incandescent sources, which is sometimes called tungsten, and the 6500 Kelvin light of HMI sources. Filters can be added to the outside of the envelope to modify the color temperature, but the balloon surface comprises a large area and thus the filter material itself can both cost an enormous amount of money and add significant weight, not to mention the difficulty in making the material stay in place during periods of wind or movement. The filters may also decrease the intensity of the illumination. Some existing balloons have provisions for holding a very small amount of filter material around the bulbs inside of the envelope. This reduces the amount of filter material required thus reduces weight and cost initially and is also more resistant to winds and movement than the exterior mounted approaches. But these filters need to be installed before filling the balloon with helium and can not be modified easily afterwards.

Both incandescent and HMI light sources are occasionally available in the same envelope at the same time with existing balloon systems, providing some measure of color selection. Dimming the sources or cross-dimming between the two sources can vary the color temperature from below 3000 Kelvin degrees to over 7000 Kelvin which is often required to match a scene or lighting requirement given by a lighting director. However, one problem with this technique involves the lack of flexibility with the HMI bulbs, which generally can only dim to about half power before extinguishing. As HMI bulbs dim, their color temperature rises rather than falling towards the incandescent range as preferred. Another problem with using both incandescent and HMI light sources in one envelope is that their combined weight adds even more to the total weight of an illumination balloon which, as noted, can already be challenging to keep its weight low. Additionally these types of light sources require sizable power feeds from the electrical mains. When two different types of bulbs are used in one envelope the number of power feeds and head feeders which go up to the balloon must be doubled, further increasing weight and cost.

One additional problem with these conventional light sources and balloon materials is the problem of keeping the bulbs from coming in contact with or even being in close proximity to the envelope material. Both types of bulbs are very hot and the envelope material melts very easily. Consequently the bulbs are generally positioned as close to the center of a spherical balloon as possible or else, in the case of a cylindrical balloon, are positioned tightly along the balloon's centerline. At the end of a lighting session, the bulbs also have to be turned off and allowed to cool for a substantial amount of time before deflating the envelope in order not to melt the envelope. These problems dictate that the balloons have a round shape rather than flat. However, round shapes have a harder time fitting into close quarters or in rooms with low ceilings.

Thus, it would be advantageous to provide an illumination balloon with an efficient and directed light source that can, among other things, change color without the need for filters. It would further be advantageous to provide an illumination balloon capable of utilizing less power or avoiding the need to connect to a high-voltage power supply. The ability to direct the light source could dramatically increase the efficiency of such a light source over conventional designs based on HMI and/or incandescent light sources. It would further be advantageous to provide an very lightweight balloon with a smaller envelope that requires significantly less helium. It would also be advantageous to provide a light source that does not have a UV component, thereby eliminating the need for a UV coating. It would additionally be advantageous to provide a light source which can operate at a sufficiently low temperature so as to not melt the envelope material. and further to have a reduced volume so that the balloon easily fits in rooms with ceiling of traditional height or through traditional door sizes without having to deflate the balloon, which would otherwise waste precious helium.

### SUMMARY OF THE INVENTION

In one aspect, one or more preferred embodiments as disclosed herein comprise a balloon-mounted light source based on LEDs cooled by a lightweight gas such as gaseous helium. In various embodiments, heat produced by the LEDs may be dissipated by a heatsink that can be minimized in size and weight by operating in a hyper-cooling environment. The inventors have recognized that heat in helium flows much more readily than heat in air, and various embodiments make use of this phenomenon in order to maintain the safe operation of the LEDs while minimizing the heatsink's size and weight.

Because helium has a low viscosity compared to air, the heat generated inside a helium balloon tends to swirl around and be emitted much more evenly over the entire surface of the balloon than if it were filled with air. Hot air rather than helium in a similar container would have higher temperature at the top with much cooler temperatures near the bottom. Ideally, the advantages of a helium environment can be employed to keep all of the LEDs in the balloon as close as possible to the same temperature and thus keep their individual forward voltages close to the same value. This approach can serve to protect the LEDs from premature failure as well as unwanted color changes. An envelope for an illumination balloon in accordance with the instant disclosure may also include a leakproof or leak-resistant seal or zipper to allow the interior of the envelope to be accessed. In one preferred embodiment, the LEDs are mounted outside the envelope. While external mounting of the LEDs could require a heatsink of increased surface area or a reduction in the total output power or number of LEDs, LEDs outside the envelope would allow for easier envelope changing and maintenance. In another embodiment, a 10 psi or similar pressure relief valve is employed to ensure the envelope is not over-inflated.

In a preferred embodiment, long series circuits of LEDs are used in order to raise the overall operating voltage which, in turn, lowers the operating amperage and allows smaller gauge wiring. Smaller gauge wiring weighs less than larger gauge wiring, further reducing helium requirements. In many cases, the increase in efficiency from embodiments disclosed herein may allow balloons of sufficient illumination to run on lower current electrical systems such as household outlets or batteries.

In another embodiment, circuit boards of a flexible nature are employed to make the circuits compact when the balloon is deflated and stowed. These flexible circuit boards may be perforated or porous in order to further reduce weight.

In still another embodiment, the LEDs comprise at least two circuits, each circuit controlling LEDs of a different color. In such an embodiment, one circuit may comprise primarily tungsten balanced LEDs, and the other circuit may comprise of primarily daylight balanced LEDs. Cross fading between these two colors allows selection of a color temperature between the two original colors. These are not to be confused with red-green-blue LED arrangements which by their limited spectrum make them unsuitable for image capture or proper color rendering. In a variation of this embodiment, more than two channels of colors could be used, and these colors could be outside the realm of tungsten and daylight. These colors could be used to supplement or extend the daylight and tungsten colors. Additional LED colors might also be used to supplement the wavelength profile of the daylight and tungsten colored LEDs, including their supporting circuits.

In another embodiment, the LEDs may be driven by a DC power source in order to eliminate or reduce flicker or visual ripple. Alternatively, AC or PWM systems could be used to reduce cost and/or weight.

In still another embodiment, the LEDs may have a separate, optional diffusion material rather than the balloon envelope. In one embodiment, the diffusion material is variable in diffusiveness. The type of diffusion is preferably of high efficiency, such as light shaping diffusion which is based upon a micro-etched or holographic process.

In still another embodiment, an illumination balloon employs high power LEDs, i.e., LEDs which are 1 watt or greater. Preferably such LEDs are surface mounted to maximize manufacturing efficiencies while allowing for proper heat dissipation. Alternatively, the light could be comprised of smaller or through-hole LEDs in order to increase the number of sources and help make the light seem more monolithic in nature and source. In the case of high power LEDs they could be individually matched to a corresponding heatsink as an assembly and then these assemblies could be linked together as an array. The individual assemblies could be suspended by wires or bungee cord in an array much like a spider's web in order to minimize the weight of the array.

In the yet another embodiment, the balloon's envelope does not include a UV filter. Preferably the envelope of the balloon is clear in the front in order to maximize the projection of light and has a reflective but opaque back and sides as to minimize spill from the back and sides. The envelope can be of a very light weight material, even a disposable material, in order to minimize weight, and, by way of example and not limitation, may comprise Mylar, Polyethylene, and/or Acetate, to name a few.

In yet another embodiment, an illumination balloon may allow relatively easy replacement of the envelope. In one preferred embodiment, access to the interior of the envelope is provided through an adhesive tape based seal or gas proof zippers or seals.

In still another embodiment, an illumination balloon's envelope comprises a mattress shape, or flattened rectangular cube shaped like a pillow. The perimeter provides attachment points, such as loops and Velcro for down lines and a place to hang filters and skirts. Such an embodiment may be particularly well suited for indoor use.

In still another embodiment, the envelope of the balloon comprises a dirigible shape for operation in windy conditions. In one embodiment, the circuitry that physically supports the LEDs may be remotely tilted and/or panned to direct the LEDs in a direction that is different from the direction of the dirigible itself.

Further, attitude stabilizing electronics may optionally be employed such that the direction of the emitted light remains steady, even in windy conditions. Conventional lighting balloons generally do not direct their light with the precision provided by the novel LED-based illumination balloon embodiments described and disclosed herein, and thus generally would not need such control. Stabilizing electronics may comprise an inertial measuring unit (IMU) and servos or other mechanical devices to pull on the down lines or change the shape of the air foils in a dirigible shaped balloon or to pan and tilt the circuitry that physically supports the LEDs in order to keep the direction of the light the same over a period of time. The IMU could consist of one or more of the following components: a magnetometer, an accelerometer, a barometer, a gyro, an acoustic ranging system, a radio distancing system, and/or an optical based distancing system.

When through-hole LEDs leads are clipped during the assembly process there are occasionally sharp burs protruding from the back side of the circuit board. These burs could cut or poke holes in an envelope. Therefore, in one embodiment, small blobs or buttons of silicone-like material are used to encapsulate the cut end of the leads. This also has the added safety aspect of electrically covering what may be the only electrically exposed conductive points on the circuit board.

### BRIEF DESCRIPTION OF THE DRAWINGS

FIG. 1 provides a perspective view of a preferred embodiment of a lighting balloon optimized for indoor use.

FIG. 2 provides a perspective view of a preferred embodiment of a lighting balloon optimized for outdoor use.

FIG. 3 provides a schematic diagram of an LED lighting system for use in the inventive balloons of FIG. 1 or FIG. 2.

FIG. 4 provides a perspective view of a preferred embodiment of an LED array used in a lighting balloon optimized for outdoor use that uses high power LEDs.

### DETAILED DESCRIPTION OF THE PREFERRED EMBODIMENTS

Before explaining the preferred embodiments in detail, it is important to understand that the invention is not limited in its application to the details of the construction illustrated and the steps described herein. The invention is capable of other embodiments and of being practiced or carried out in a variety of ways. It is to be understood that the phraseology and terminology employed herein is for the purpose of description and not of limitation.

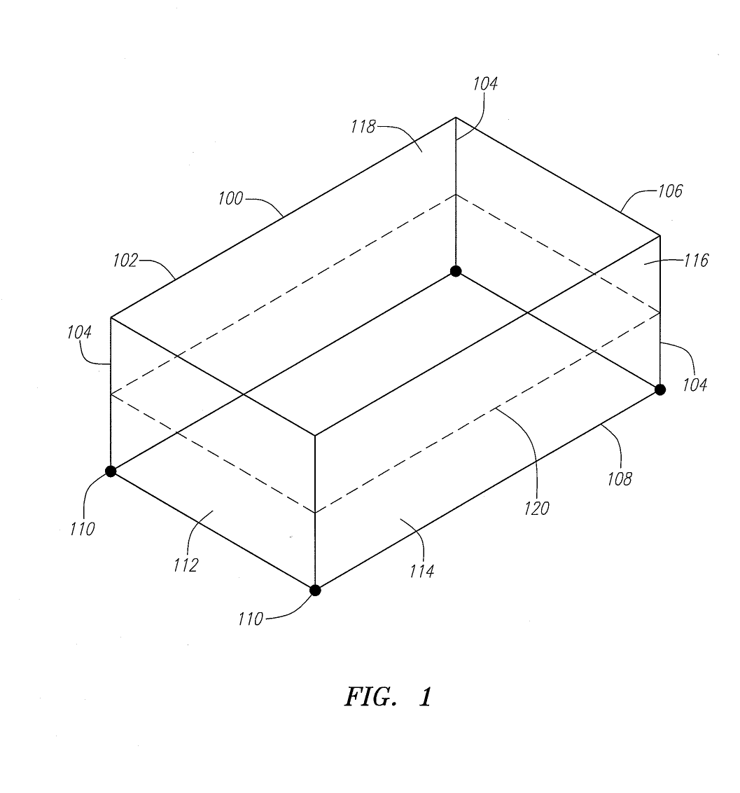

Referring now to the drawings, wherein like reference numerals indicate the same parts throughout the several views, a representative lighting balloon 100 optimized for indoor use is shown FIG. 1. In a preferred embodiment, balloon 100 comprises: an envelope 102 having a generally flattened, or mattress shape; a plurality of supports 104 tying a front side 106 to a back side 108 such that envelope 102 maintains its general shape when inflated with helium; and a plurality of tie-down points 110 for the tether lines 170. The tether line 170 may also, if desired, be combined with a power line for electrically connecting the LEDs to an external power source. Preferably envelope 102 is fabricated from a thin, lightweight, flexible material which is relatively impermeable. By way of example and not limitation, representative materials include Mylar, coated nylon, polyester, polyethylene, acetate, etc. Preferably front side 106 comprises a clear or highly translucent material and back side 108 and sides 112, 114, 116, and 118 comprise a material which is reflective, but opaque. Optionally, sides 108 and 112, 114, 116, and 118 may be coated on the interior surface with vaporized aluminum, or other material, to improve their reflectivity. Centerline 120 defines a plane over which an arrangement of semiconductor light elements (e.g., LED lamps) may be positioned.

The incorporation of LED lamps may allow balloon 100 to have a generally flattened shape, which contrasts with the spherical or cylindrical shape of conventional illumination balloon devices. With current technology, LED lamps can be four times as efficient as incandescent lamps and, since the LED light is projected in one direction instead of omni-directionally, often times LEDs provide as much as ten times the light in the direction of interest. Since only a fraction (e.g., one-tenth) the electrical power is delivered to the balloon, as compared with conventional illumination balloons, the heat dissipating requirements of the overall system are likewise substantially reduced, and the risk of damage to envelope 102 from heat producing components is eliminated or substantially mitigated. The flattened shape of balloon 100 allows the balloon to fly in environments where a tradition spherical or cylindrical shaped balloon would not fit and could not be used.

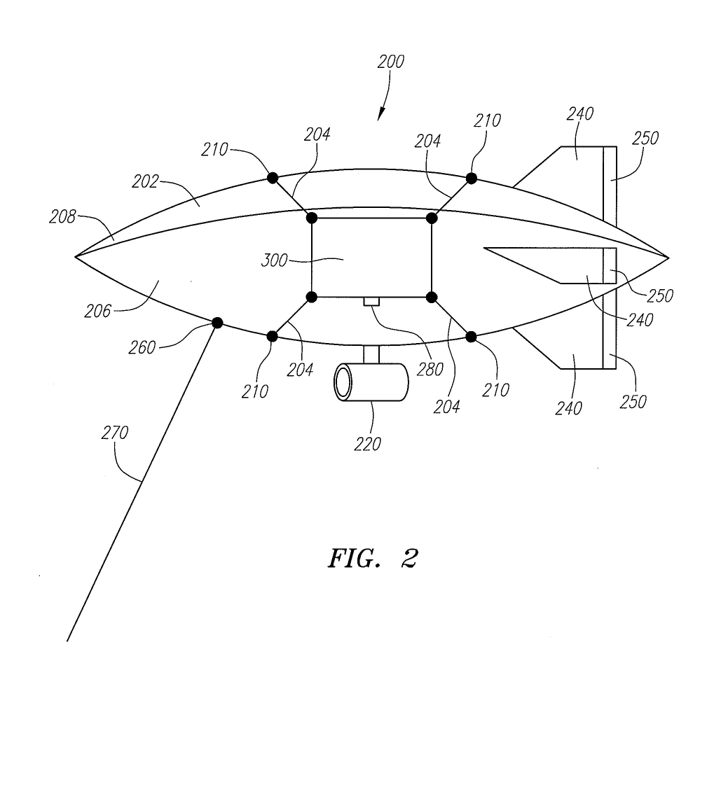

Turning to FIG. 2, a dirigible shaped balloon 200 is well suited to an outdoor environment where overhead clearance is less likely a limiting factor and where wind is more of a factor than in an indoor environment. In a preferred embodiment, balloon 200 comprises an envelope 202 defining a generally ellipsoidal or roughly football-shaped volume; a plurality of supports 204 for suspending an LED lighting system 300; and a plurality of hook points 210. Preferably envelope 202 is likewise fabricated from a thin, lightweight, flexible material which is relatively impermeable, such as the materials described above in connection with FIG. 1. Preferably front side 206 comprises a clear or highly translucent material and back side 208 comprise a material which is reflective, but opaque. Optionally, sides 208 may be coated on their interior surface with vaporized aluminum, or other material, to improve their reflectivity. The balloon may also have a plurality of tie-down 260 points for the tether lines 270. The tether line 270 may also be combined with a power line which electrically connects the LEDs to an external power source. The balloon may also include fins 240 near the tail to help stabilize the balloon in windy conditions.

Optionally, balloon 200 may include one or more thrusters 220 for maintaining the attitude of balloon 200 in moving air or to generally position balloon 200 in a loosely tethered environment. The balloon may also include moveable elements 250 on the fins 240 that help maintain the attitude of the balloon in wind. The attitude of the LEDs can be measured, for example, by an IMU 280 mounted on the plane of LEDs, and this measurement may be used to provide feedback for controlling the attitude according to techniques generally known in the art of attitude stabilization.

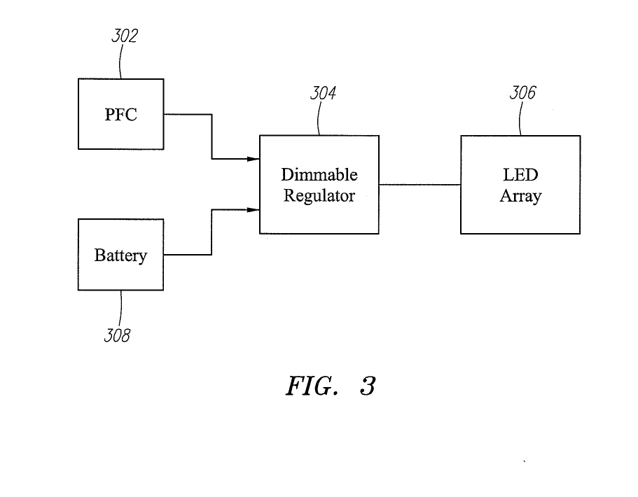

With reference to FIGS. 1, 2, 3 and 4, a sizeable percentage of the weight which must be lifted by balloon 100 or 200 is the weight of the power wires 130 or 230 which provide electrical power to the light source. For a given material, e.g., copper, wire losses are generally dependent on wire diameter and the electrical current flowing in the wire. Thus, for a given amount of electrical power delivered to the lighting system in the balloon, the higher the voltage delivered, the lower the electrical current will be, and thus the smaller the wires may be. The smaller the wires, the smaller the envelope required to lift the wires and the less helium that needs to be used to fill the balloon. Accordingly, in one preferred embodiment of an illumination balloon, the LED lighting system is designed to operate from a source of 100 Volts DC, or higher, of electrical power. Besides allowing smaller wires, an added benefit of such an approach is that power supply systems for world-wide use must be power factor corrected. Power factor correction (PFC) circuits are generally available for use at any household voltage used in the world (85-250 VAC) which provide about 360 volts DC at their output. A preferred LED lighting system 300 may comprise a power factor correction (PFC) circuit 302, a dimmable regulator 304, an LED array 306, and a battery 308. It should be noted that isolation from the main power may be obtained in a variety of ways, if so desired. For example, an isolation transformer could optionally be inserted between the main electrical power source and the lighting system, or else isolation could be provided by the PFC circuit 302, or else isolation may be provided by the regulator 304. The electrical power could come from a battery 308 and which feeds the dimmable regulator 304.

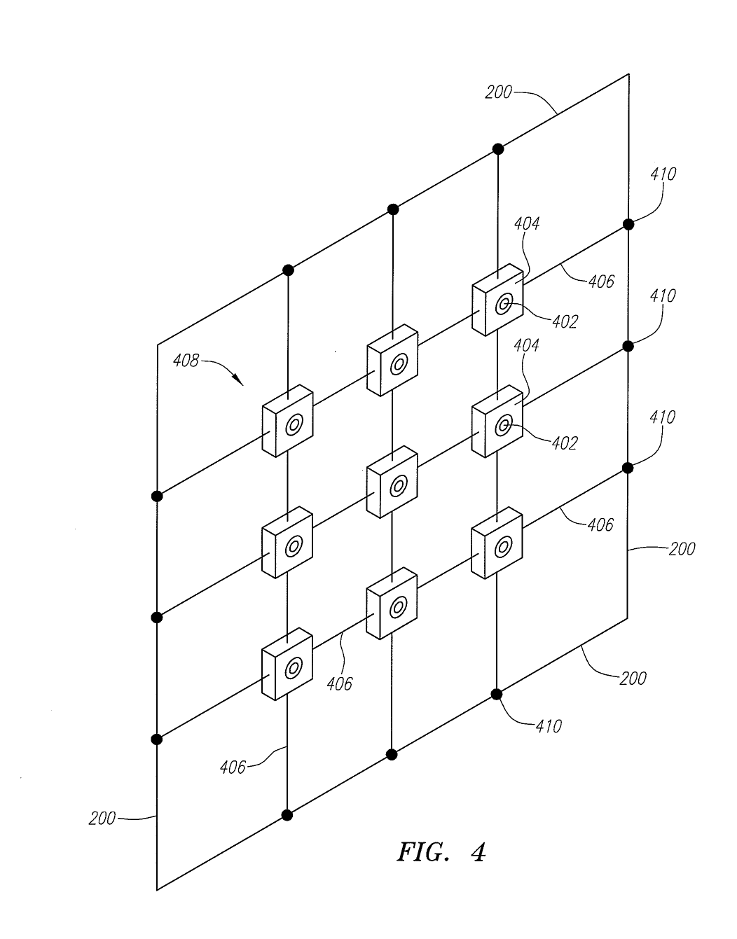

Turning to FIG. 4, an arrangement of high power LEDs 402 are attached to a set of heatsinks 404 and the individual heatsinks 404 are connected by flexible strandlike members (e.g., bungee cords or wires) 406 thus collectively forming a high power LED array 408 having illumination sources spread across two dimensions. The LED array 408 may be connected at the outside edges 400 to the balloon envelope 100 or 200 at the hook points 410. While the arrangement shown in FIG. 4 depicts a grid of generally evenly spaced heatsinks 404 to which are attached the high power LED lamps, it will be appreciated that other arrangements of heatsinks and LED lamps may be used—for example, a rectangular pattern, a radial (or “spiderweb”) pattern, or an uneven pattern in which LEDs or heatsinks are clustered together.

In a preferred embodiment, an LED array comprises a parallel arrangement of strings of LED lamps wired in series. For example, a sufficient number of LED lamps may be wired in series to directly achieve a relatively high operating voltage, e.g., 300 Volts. A sufficient number of such strings may be wired in parallel to provide an operating current of 3.3 Amps so as to provide a total of one Kilowatt of LED lighting. Such a light source may deliver as much light to a scene as perhaps eight to ten Kilowatts of incandescent lighting. In such a system of LED lights, 20-gauge wires can be used to deliver the power to the LED array at the balloon without suffering significant line loss. In addition, if regulator 304 is embodied as a current regulator, the power delivered to the LED array can be maintained at a constant level regardless of line losses in power lines 130 or 230. In the case that the electrical power is provided from a battery 308 and the regulator 304 is embodied as a current regulator, the current regulator could maintain power delivered to the LED array at a constant level even as the battery voltage gradually discharges or decays over time until such time as the battery's capacity was completely exhausted. Details of possible embodiments of a power regulator 5710 are described in copending U.S. application Ser. No. 10/708,717 filed Mar. 19, 2004, entitled “Omni-Voltage Direct Current Power Supply,” hereby incorporated by reference as if set forth fully herein.

While preferred embodiments of the invention have been described herein, many variations are possible which remain within the concept and scope of the invention. Such variations would become clear to one of ordinary skill in the art after inspection of the specification and the drawings. The invention therefore is not to be restricted except within the spirit and scope of any appended claims.

What is claimed is:

1. A lighter than air craft comprising:
a balloon envelope; and
an LED array for directing light at an exterior subject.

2. The lighter than air craft of claim 1 wherein said LED array comprises two or more groups of LEDs, each group of LEDs having a distinct color temperature.

3. The lighter than air craft of claim 1 further comprising a battery to provide electrical power to said LED.

4. The lighter than air craft of claim 1 wherein said balloon envelope is substantially mattress-shaped.

5. The lighter than air craft of claim 1 wherein said balloon envelope is substantially dirigible-shaped.

6. The lighter than air craft of claim 1 further comprising a power supply to power said LED array, said power supply configured to operate from AC power.

7. The lighter than air craft of claim 1 wherein said power supply comprises a PFC circuit.

8. The lighter than air craft of claim 1 further comprising an attitude stabilization system.

9. The lighter than air craft of claim 1 wherein said LED array comprises a plurality of LEDs rated for at least 1 watt of power.

10. The lighter than air craft of claim 1 wherein said LED array comprises a plurality of multicolor LEDs.

11. The lighter than air craft of claim 1 wherein said balloon envelope is transparent.

12. The lighter than air craft of claim 1 further comprising a diffusion filter.

13. The lighter than air craft of claim 1 further comprising filtration.

14. The lighter than air craft of claim 1 further comprising a servo system for maintaining an illuminated area.

15. The lighter than air craft of claim 1 further wherein said LED array is powered directly from an AC main circuit.

16. The lighter than air craft of claim 1 wherein said LED array is dimmable.

17. The lighter than air craft of claim 16 wherein LED array is controlled via PWM.

18. The lighter than air craft of claim 1 wherein said LED array operated from high voltage DC.

19. The lighter than air craft of claim 1 wherein said LED array is mounted to a flexible circuit board.

20. The lighter than air craft of claim 1 wherein said LED array is suspended as a wire web.
